(19) United States
(12) Patent Application Publication
(10) Pub. No.: US 2014/0140804 A1
(43) Pub. Date: May 22, 2014

(54) MAGNETIC RACK SYSTEM, METHOD FOR USING A MAGNETIC RACK SYSTEM AND USE OF A MAGNETIC RACK SYSTEM

(71) Applicant: QIAGEN GMBH, Hilden (DE)

(72) Inventors: Maximilian FOCKE, Duesseldorf (DE); Lothar BREITKOPF, Bonn (DE); Karen KOWALEWSKI, Solingen (DE); Thorsten SINGER, Solingen (DE)

(73) Assignee: QIAGEN GMBH, Hilden (DE)

(21) Appl. No.: 14/057,538

(22) Filed: Oct. 18, 2013

(30) Foreign Application Priority Data
Nov. 20, 2012 (EP) 12 193 347.7

(51) Int. Cl. B01L 9/06

(52) U.S. Cl. CPC B01L 9/06
USPC 414/801; 422/562

(57) ABSTRACT

Magnetic rack system comprising a holder having trough-holes for receiving tubes, a base having a plurality of receptacles with at least one magnet, wherein trough-holes in the holder are arranged relative to the base such that each tube can be positioned in a respective receptacle in a pre-determined position relative to the magnet, and an adapter, wherein the adapter is designed to allow transmission of motion to the tubes (2) positioned in the holder (1).

### CROSS REFERENCE TO RELATED APPLICATIONS

This application claims priority to European Application No. 12 193 347.7, filed Nov. 20, 2012, the content of which is incorporated herein by reference in its entirety.

### BACKGROUND

1. Filed of the Invention

The invention pertains to the field of magnetic rack systems, especially used for separating magnetic particles, for example magnetic beads, from a non-magnetic medium, especially a liquid in the field of chemical and/or biological substances, more especially in the field of a sample in biotechnology, for example blood. Especially, the magnetic rack system can be used with regard to molecular biological protocols and/or medical diagnostic field.

2. Description of Related Art

WO 2008/145711 A2 discloses a magnetic separating device for isolating magnetically labelled particles from a non-magnetic medium, wherein a body portion having a magnetising portion for providing a magnetic field and a sample vessel retaining portion for retaining at least one sample vessel are provided.

Although the device and method disclosed in WO 2008/145711 A2 obtain good results, the configuration cannot easily be used with standard laboratory equipment.

Thus, if a magnetic bead protocol requires a heating step, every reaction tube has to be separately moved to a heating block or water bath and moved back for magnetic separation. Further, if a magnetic bead protocol requires bead mixing, either every reaction tube has to be separately moved to a shaker/vortexer or the complete rack has to be held by hand put on a shaker/vortexer. This makes longer mixing times very inconvenient and not really practicable.

The limitations of the already existing magnetic racks result in inconvenient protocols with a large number of handling steps. Every reaction tube has to be handled individually, for example to put it into a shaker, water bath and back to the magnetic bead separator. As a consequence the disadvantages in handling described above leads to the result that manual protocols based on magnetic beads are very inconvenient and have gained little or no acceptance in the market over years.

### SUMMARY

The object of the present invention is to provide a suitable device and method for handling tubes with magnetic beads, especially in the field of biology, which is convenient and overcomes at least one of the above-mentioned problems.

This object is solved by the subject-matter of the independent claims.

The present invention is based on the finding that a combination of a magnetic rack system comprising a holder for holding at least two, preferably 12 tubes, a base having a plurality of receptacles and at least one magnet, and an adapter provide for a convenient manual and semi-automatic processing of magnetic beads.

The holder and the base allow simultaneous handling of a plurality of tubes. The holder can be adapted to be used with standard laboratory equipment, for example shakers and/or vortex devices with or without the adapter. The distance between through-holes in the holder for receiving tubes is preferably such that it fits on standard top parts of commonly used laboratory equipment (shakers) and the distances between the tubes is preferably appropriate for multi-pipets.

### BRIEF DESCRIPTION OF THE DRAWINGS

FIGS. 1-3b represent embodiments as described herein.

### DETAILED DESCRIPTION OF A PREFERRED EMBODIMENT

According to the invention, the term “tube” encompasses any reservoir, vessel or micro-environment suitable for containing a chemical and/or biological fluid. Preferably, the tube can contain several ml of fluid. The tube is adapted, to contain not more than 50 ml, more preferably not more than 15 ml of fluid, especially preferably not more than 2 ml of fluid.

According to the invention, the term “adapter” encompasses any means which allow for a mechanical connection between a laboratory device, for example a shaker, vortexer or thermomixer, and the holder. The connection provided by the adapter can be formed directly between the holder and the laboratory equipment but as well indirectly via the tubes held by the holder such that the adapter provides for a form closure between the tubes and the adapter, wherein the adapter is mounted on the laboratory equipment.

According to the invention, the term “laboratory equipment” encompasses any device which allows for heating, cooling, shaking, stirring and/or mixing of the liquid contained in the tubes.

Thus, the term “laboratory equipment” comprises a shaker, a vortexer, a thermocycler, a thermomixer and a water bath for heating and/or cooling of the tubes.

Preferably, the holder can comprise or be made of a foamed polymer (for example SBS (styrene-butadiene-styrene)). This allows for a holder with low weight and which is compressible which in turn allows for a flexible geometry (including tolerances) in manufacturing the holder. Further, the holder can be used as a tube floater in a water bath.

Preferably, the adapter can comprise or be made of a foamed polymer (for example SBS (styrene-butadiene-styrene)). This allows for an adapter with low weight and which is compressible which in turn allows for a flexible geometry (including tolerances in manufacturing the adapter.

Preferably, the base can comprise or be made of a polymer, especially for example POM (polyoxymethylene) which allows manufacturing of a very solid and robust base to ensure stability when the holder is put on and removed during molecular biological protocols. In an alternative embodiment, the base can comprise or be made of aluminium.

In a preferred embodiment, the adapter can be formed as a plate comprising receptacles for receiving the tubes held by the holder. The receptacles can be formed for the tubes to be held by the holder in form closure with the receptacles. The adapter in turn can be mounted on the laboratory equipment such that a form closure and/or force closure is used.

For higher sample throughput two or more holders can be processed simultaneously in a laboratory device, for example a shaker. When processing two or more holders on one laboratory device at least one of the tubes of one line is exposed. Thus, only tube(s) of one line in the holder are inserted in the receptacles of the laboratory equipment.

Other objects, features, advantages and aspects of the present application will become apparent to those skilled in the art from the following description and appended claims. It should be understood, however, that the following description, appended claims, and specific examples, while indicating preferred embodiments of the application, are given by way of illustration only. Various changes and modifications within the spirit and scope of the disclosed invention will become readily apparent to those skilled in the art reading the following.

Examples of the invention will now be described with reference to the accompanying drawings in which:

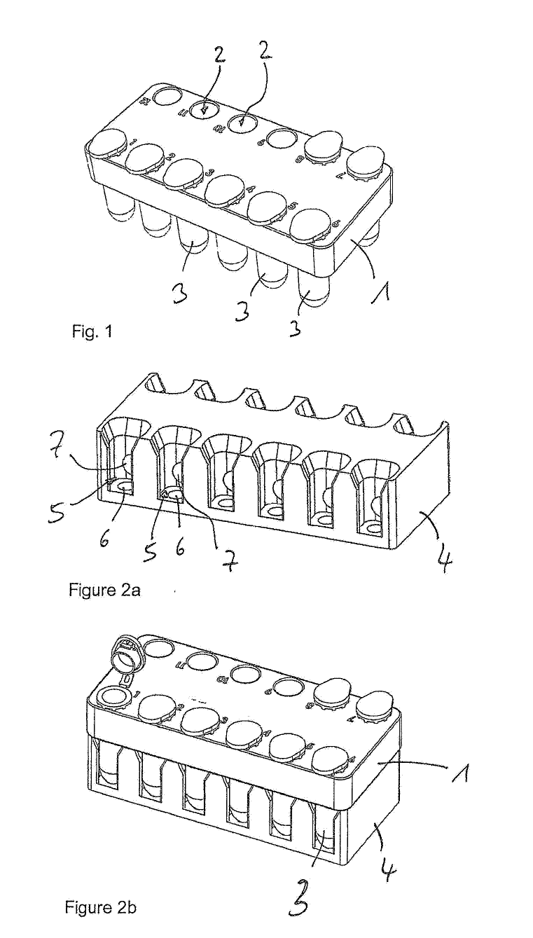

FIG. 1 shows a holder of the magnetic rack system according to the invention, in which tubes are inserted;

FIG. 2a shows a base of the magnetic rack system according to the invention;

FIG. 2b shows the holder with the tubes according to FIG. 1 put on the base according to FIG. 2a;

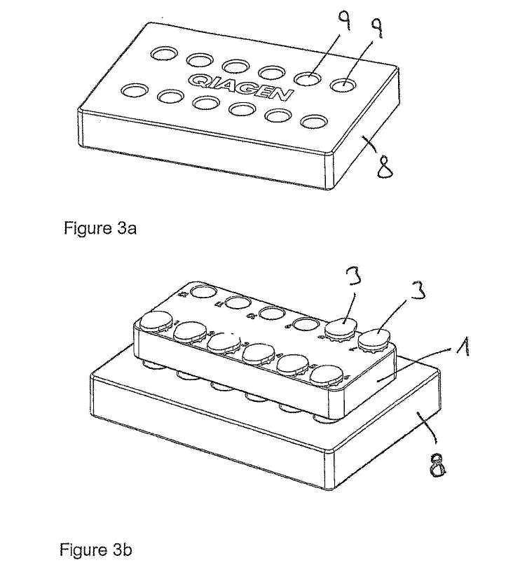

FIG. 3a shows an adapter of the magnetic rack system according to the invention; and

FIG. 3b shows the holder with the tubes according FIG. 1 put on the adapter according to FIG. 3a.

FIG. 1 shows a holder 1 of the magnetic rack system according to the invention. The holder 1 is formed as a plate with through-holes 2 for receiving tubes 3. The tubes 3 have a pre-determined alignment with regard to the through-holes in the holder 1. The through-holes 2 are arranged in two lines and six columns. Adjacent through-holes 2 in one line have a distance equal to 0.9 to 3.6 cm, the lines have a distance equal to 0.9 to 3.6 cm.

FIG. 2a and FIG. 2b show a base 4 of the magnetic rack system according to the invention. Receptacles 5 are provided for receiving the tubes 3 held by the holder 1. The distance of the receptacles 5 in the base 4 corresponds to the distances of the through-holes 2 in the holder 1. A deepening 6 is formed in each of the receptacles 5 for surrounding an end of the tubes 3. In each of the receptacles 5 a magnet or magnet portion 7 is exposed. The magnet 7 can interact with magnetic particles, especially magnetic beads, contained in the tubes 3 when the tubes 3 are put in the receptacles 5. The holder 1 can comprise an apron extending downwardly which surrounds the outer circumference of the base 4 as a measure to hold the holder 1 in place and alignment.

FIG. 3a and FIG. 3b show an adapter 8 containing receptacles 9 for receiving the tubes 3 held by the holder 1. The receptacles 9 are arranged in distances which correspond to the distances used for the distances of the through-holes 2 in the holder 1.

1. A magnetic rack system comprising:
a. a holder having trough-holes for receiving tubes and
b. a base having a plurality of receptacles with at least one magnet, wherein the trough-holes of the holder are arranged relative to the base such that each tube can be positioned in a respective receptacle in a pre-determined position relative to the magnet, and
c. an adapter, wherein the adapter is designed to allow transmission of motion to the tubes positioned in the holder.

2. The magnetic rack system according to claim 1, wherein the through-holes in the holder are arranged in lines and columns, the lines having a spacing of approximately 0.9 to 3.6 cm, and the columns having a spacing of approximately 0.9 to 3.6 cm, wherein positions of the receptacles in the base are arranged corresponding to a position of the through-holes in the holder.

3. The magnetic rack system according to claim 1, wherein the holder comprises a foamed polymer.

4. The magnetic rack system according to claim 1, wherein the adapter comprises a foamed polymer.

5. The magnetic rack system according to claim 1, wherein the base comprises a solid polymer and/or aluminium housing.

6. The magnetic rack system according to claim 1, wherein the adapter is in a geometry thereof, adapted for a transmission of motion to the tubes positioned in the holder.

7. The magnetic rack system according to claim 1, wherein the adapter is formed as a plate comprising receptacles for receiving the tubes positioned in the holder.

8. A method for handling tubes positioned in a holder, optionally a holder of a magnetic rack system according to claims 1, wherein the method comprises inserting at least one group of the tubes into receptacles of a laboratory device, optionally a shaker, while keeping at least one further group of tubes outside of the receptacles.
